(19) United States
(12) Patent Application Publication
(10) Pub. No.: US 2024/0424748 A1
(43) Pub. Date: Dec. 26, 2024

(54) PRE-FORMING MOLD, FORMING MOLD AND PREPARATION METHOD FOR CARBON FIBER COMPOSITE MATERIAL

(71) Applicant: XIAMEN HONGJIWEIYE INDUSTRIAL CO., LTD., Xiamen (CN)

(72) Inventors: Jingshan WANG, Xiamen (CN); Shunhe CHEN, Xiamen (CN); Haibing ZHANG, Xiamen (CN)

(73) Assignee: XIAMEN HONGJIWEIYE INDUSTRIAL CO., LTD., Xiamen (CN)

(21) Appl. No.: 18/824,015

(22) Filed: Sep. 4, 2024

Related U.S. Application Data
(63) Continuation-in-part of application No. PCT/CN2022/111452, filed on Aug. 10, 2022.

(30) Foreign Application Priority Data
Jul. 6, 2022 (CN) 202210798163.3

(51) Int. Cl. B29C 70/34; B29B 11/06; B29K 307/04

(52) U.S. Cl. CPC B29C 70/345; B29B 11/06; B29C 70/342; B29K 2307/04; B29K 2905/00

(57) ABSTRACT

A pre-forming mold for a carbon fiber composite material includes a pre-forming shell mold detachably spliced, the pre-forming shell mold is provided with a pre-forming cavity adapted to a structure of a formed product, an inner wall of the pre-forming cavity is used for laying a plurality of layers of pre-forming layers of carbon fiber composite materials, and the pre-forming layers are used for forming pre-forming pieces of products. The disclosure also discloses a forming mold for a carbon fiber composite material, including a curing mold, an air pipe and the above-mentioned pre-forming mold, the curing mold is provided with a curing cavity used for containing the pre-forming shell mold, the air pipe adopts nylon air pipe and is arranged in the pre-forming cavity, and the nylon air pipe supports the pre-molding layer to be tightly attached to the inner wall of the pre-forming cavity in an inflated state.

### CROSS-REFERENCE TO RELATED APPLICATIONS

This application is a continuation-in-part of International Application No. PCT/CN2022/111452, filed on Aug. 10, 2022, which claims priority to Chinese Patent Application No. 202210798163.3, filed on Jul. 6, 2022. All of the aforementioned applications are incorporated herein by reference in their entireties.

### TECHNICAL FIELD

The present disclosure herein relates to the technical field of carbon fiber, and in particular to a pre-forming mold, a forming mold and a preparation method for a carbon fiber composite material.

### BACKGROUND

The carbon fiber composite materials, with advantages of being lightweight and high strength, have been widely applied, especially in the field of premium bicycles. As people's living standards continue to improve, the demand for premium bicycles has grown significantly, and cycling has become increasingly popular. People are now seeking lighter cycling tools, and carbon fiber, due to its lightweight and strong characteristics, is very suitable for manufacturing lightweight bicycles.

In the prior art, when carbon fiber composite materials are used to manufacture products, they are typically produced by laying carbon fiber yarn layers in the curing cavity of a metal mold, and then curing and forming the material within the mold through high-temperature heating. However, this method is cumbersome, inefficient, and requires the use of release agents for demolding. Moreover, after demolding, the metal mold may retain excess resin. Furthermore, different product components require varying structures of the curing cavity in the metal mold, necessitating the use of multiple metal molds, which leads to high costs. Additionally, for carbon fiber products with textured appearance requirements, the fiber stretching during the metal mold closing process can easily lead to distorted textures and poor aesthetics in the final product. This not only makes manufacturing difficult and has a low yield rate, but also results in higher production costs.

### SUMMARY

The present disclosure proposes a pre-forming mold, a forming mold and a preparation method for a carbon fiber composite material to solve the above problems.

In order to achieve the above objects, the present disclosure adopts the following technical solutions: a pre-forming mold for a carbon fiber composite material, comprising a pre-forming shell mold detachably spliced, the pre-forming shell mold is provided with a pre-forming cavity adapted to a structure of a formed product, an inner wall of the pre-forming cavity is used for laying a pre-forming layer, and the pre-forming layer is used for forming a pre-forming piece of a product.

A forming mold for a carbon fiber composite material, comprising a curing mold, an air pipe and the above-mentioned pre-forming mold for the carbon fiber composite material, the curing mold is provided with a curing cavity used for containing the pre-forming shell mold, the air pipe is arranged in the pre-forming cavity, the air pipe adopts nylon air pipe, and the nylon air pipe supports the pre-molding layer to be tightly attached to the inner wall of the pre-molding cavity in an inflated state.

Preferably, a first texture is provided on an inner wall surface of the pre-forming cavity, and the first texture is used for forming a second texture on an appearance surface of the pre-forming piece.

Preferably, the first texture is arranged convex or concave.

Preferably, the inner wall surface of the pre-forming cavity is one or a combination of a matte surface and a polishing surface.

Preferably, the pre-forming shell mold comprises a plurality of groups of split shell molds spliced together, a plurality of anti-overflow cavities are provided on the pre-forming shell mold, and the anti-overflow cavities are communicated with the pre-molding cavity.

Preferably, an anti-overflow groove is provided on the split shell mold, and the anti-overflow cavity is formed by cooperation between the anti-overflow grooves on adjacent groups of the split shell molds, or by cooperation between the anti-overflow grooves and splicing surfaces on adjacent groups of the split shell molds.

Preferably, the anti-overflow cavity is arranged along a contour line of the pre-forming cavity.

Preferably, two adjacent groups of the split shell molds are detachably spliced by means of an engaging structure.

Preferably, the curing mold includes an upper curing mold and a lower curing mold, the upper curing mold is arranged right above the lower curing mold in a lifting mode, a bottom side of the upper curing mold is provided with an upper curing groove, a top side of the lower curing mold is provided with a lower curing groove, and the upper curing groove and the lower curing groove are matched to form the curing cavity used for containing the pre-forming shell mold.

Preferably, the pre-forming layer includes a plurality of layers and is made of the carbon fiber composite material, the curing mold is made of a metal material, and the pre-forming shell mold is made of a plastic material.

A preparation method for a carbon fiber composite material, using above-mentioned forming mold for the carbon fiber composite material for preparing, comprising the following steps:
Step 1, pre-manufacturing a plurality of groups of split shell molds, and laying a carbon fiber composite material on the inner sides of the split shell molds to form pre-forming layers;
Step 2, assembling and combining the plurality of groups of split shell molds to form a pre-forming shell mold, tightly connecting and matching the pre-forming layers on the inner sides of each group of the split shell molds to form a pre-forming piece of a product, and pre-placing the air pipe, that is, nylon air pipe, into an inner portion of the pre-forming piece;
Step 3, inflating air into the nylon air pipe, and keeping the pressure for a few seconds, so that the nylon air pipe expands to support the pre-forming layers to be tightly attached to the inner wall of a pre-forming cavity of the pre-forming shell mold;
Step 4, placing the pre-forming shell mold into a curing cavity of a curing mold, heating the curing mold, and pressurizing the nylon air pipe, wherein the heating process and the pressurization process are performed at the same time until the temperature and the pressure reach the requirement of curing forming, and then the pressure is continuously kept until the pre-forming piece is completely formed and cured to form an initial product; and
Step 5, opening the curing mold, stripping off the pre-forming shell mold from the surface of the initial product, taking out the initial product, and performing machining and surface treatment to obtain a finished product.

After adopting the above technical solution, compared with the background, the present disclosure has the following advantages.

Firstly, the present disclosure provides a pre-forming mold, a forming mold and a preparation method for a carbon fiber composite material. When in use, the pre-forming layer of the carbon fiber composite material is first laid on the inner side of each split shell mold. Subsequently, each group of split shell mold is assembled to form the pre-forming shell mold. The pre-forming shell mold is then placed into a curing mold for curing and forming. The pre-forming cavity structure of the pre-forming shell mold is matched with the structure of the product to be formed. During the laying process, the carbon fiber composite material is laid layer by layer from the outside to the inside, so as to directly reinforce the local area that needs to be strengthened inside, ensuring the overall strength of the formed product. Meanwhile, it achieves a smooth and flat surface on the product, eliminating the need for subsequent surface smoothing processes after the product is formed, and saving labor costs.

Secondly, the present disclosure provides a pre-forming mold, a forming mold, and a forming method for a carbon fiber composite material, which are convenient to demold, the pre-forming shell mold can be taken out without a release agent, the pre-forming shell mold made of the plastic material can be directly stripped off from the surface of the cured and formed product, clean and non-residue in the curing mold can be continuously used, the mold is not required to be cleaned for a long time, the demolding operation is simple and convenient, the product is not easy to damage, compared with a traditional process mode, the production process is simplified, the process time is shortened, and the enterprise production cost is reduced.

Thirdly, the present disclosure provides a pre-forming mold, a forming mold, and a forming method for a carbon fiber composite material. The pre-forming cavity structure of the pre-forming shell mold can be adjusted according to the actual product structure requirements. The curing mold can be a general mold, and compared to adjusting the structure of the curing mold made of metal material, the cost and difficulty of adjusting the pre-forming shell mold made of plastic material are both lower, thereby saving the production cost of the enterprise.

Lastly, the present disclosure provides a pre-forming mold, a forming mold, and a forming method for a carbon fiber composite material. The texture on the inner surface wall of the pre-forming cavity can be adjusted accordingly according to the appearance texture requirements of the actual product. The texture is formed on the appearance surface of the product while heating, pressurizing and curing the formed product to obtain a formed product with textures, so that the texture manufacturing difficulty is small, the appearance surface of the product is not prone to texture distortion, the appearance quality is good, and the yield rate is high.

### BRIEF DESCRIPTION OF THE DRAWINGS

FIG. 1 is a schematic diagram of the forming process flow according to the present disclosure.

FIG. 2 is a first structure schematic diagram of a forming mold according to the present disclosure.

FIG. 3 is a first structure schematic diagram of a pre-forming shell mold according to the present disclosure.

FIG. 4 is a second structure schematic diagram of a forming mold according to the present disclosure.

FIG. 5 is a second structure schematic diagram of a pre-forming shell mold according to the present disclosure.

FIG. 6 is a structure schematic diagram of a rim pre-forming mold in a splicing state according to the present disclosure.

FIG. 7 is a partially enlarged schematic diagram of part A in FIG. 6.

FIG. 8 is a structure schematic diagram of a rim pre-forming mold in an exploded state according to the present disclosure.

FIG. 9 is a partially enlarged schematic diagram of part B in FIG. 8.

FIG. 10 is a partially enlarged schematic diagram of part C in FIG. 8.

FIG. 11 is a structure schematic diagram of a rim pre-forming layer according to the present disclosure.

FIG. 12 is a structure schematic diagram of an upper shell mold section according to the present disclosure.

FIG. 13 is a structure schematic diagram of a rim pre-forming section according to the present disclosure.

### DETAILED DESCRIPTION OF THE EMBODIMENTS

In order to make the purpose, technical solutions and advantages of the present disclosure more clear, the present disclosure will be further described in detail below with reference to the accompanying drawings and embodiments. It should be understood that the specific embodiments described here are only used to explain the present disclosure, and are not intended to limit the present disclosure.

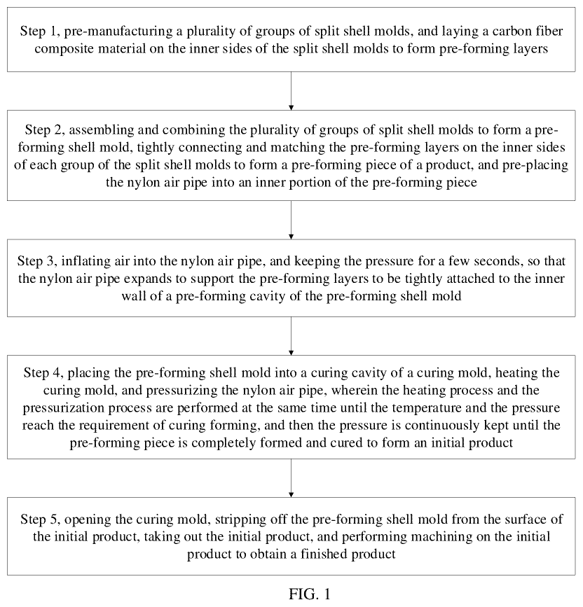

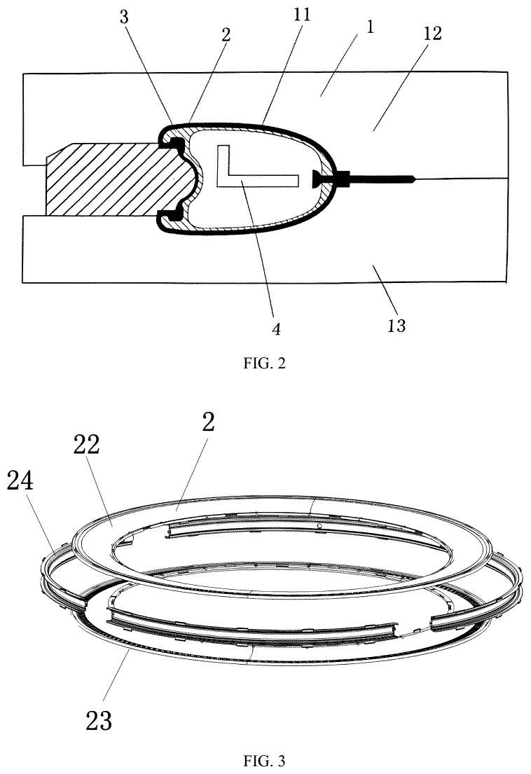

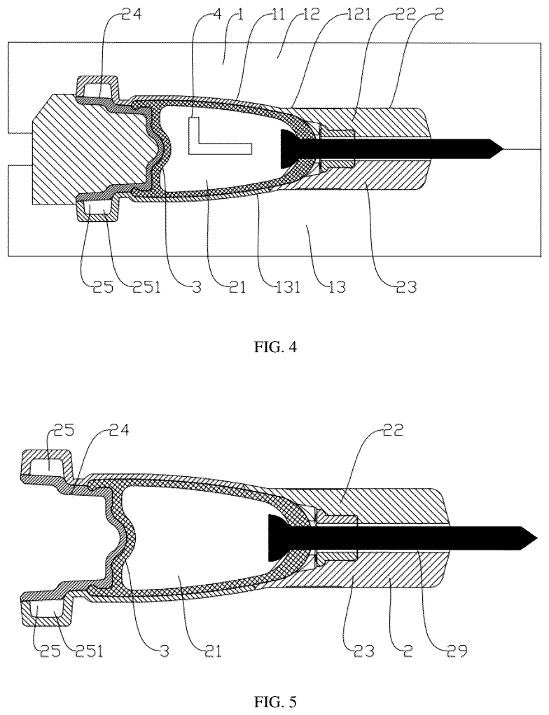

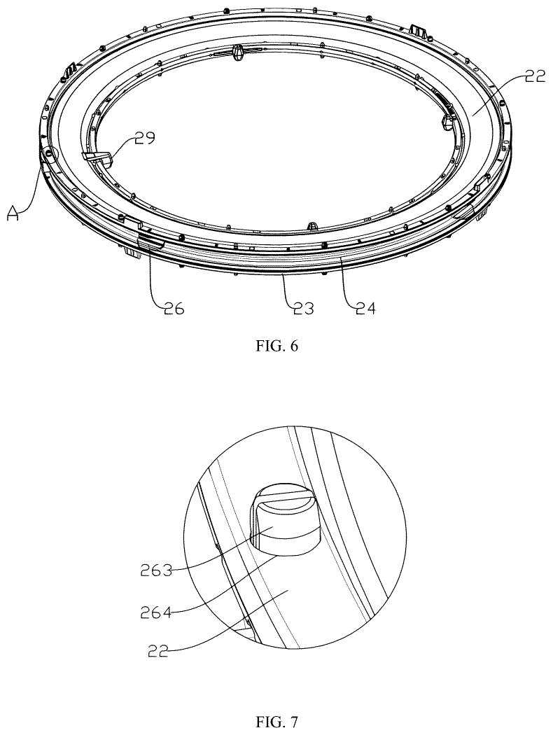

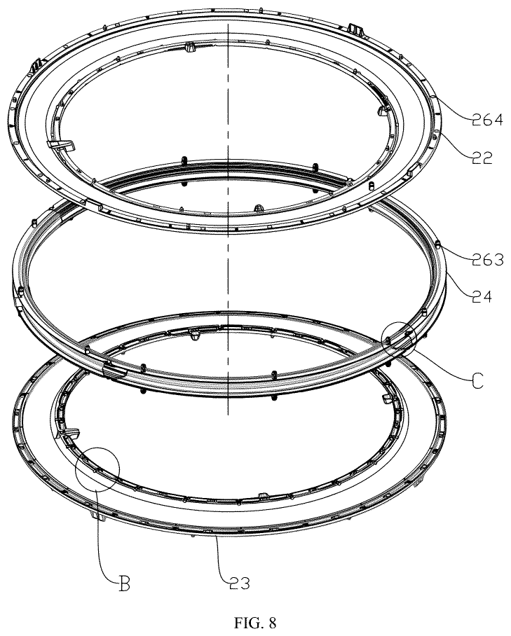

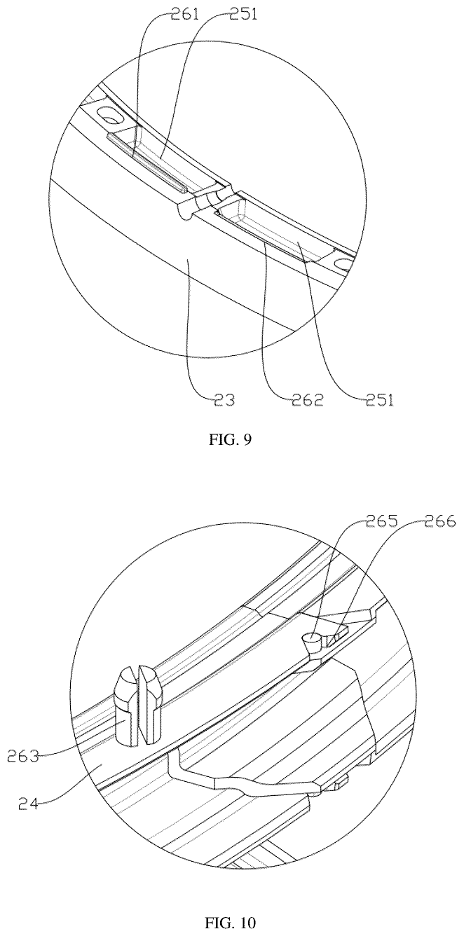

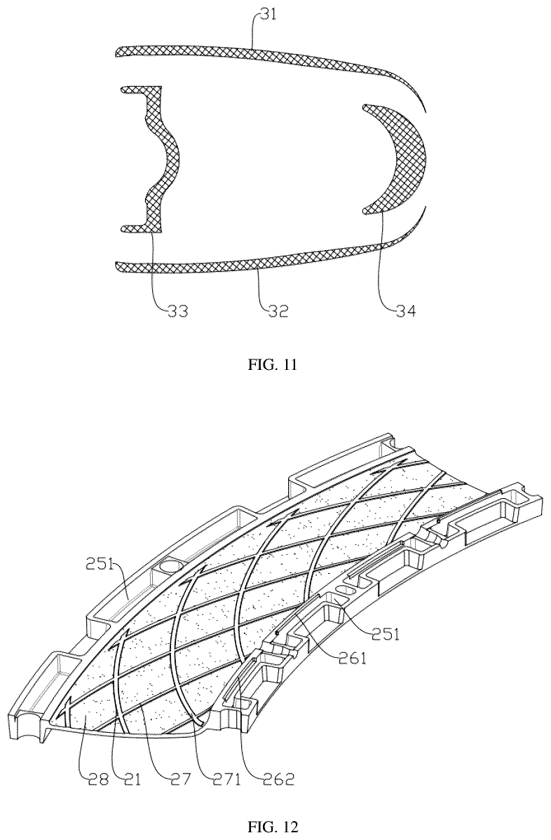

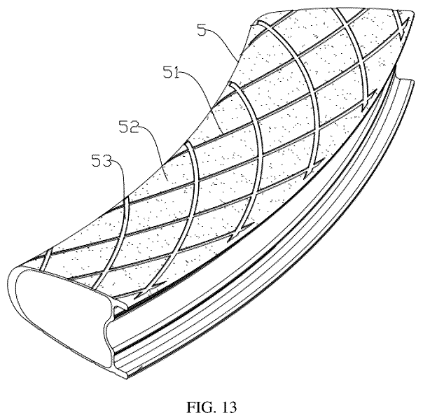

As shown in FIGS. 1 to 13, the present disclosure discloses a pre-forming mold for a carbon fiber composite material. In this embodiment, products formed from carbon fiber composite materials include but are not limited to bicycle rims, bicycle frames, bicycle handlebars, etc., this embodiment specifically takes a bicycle rim as an example.

The pre-forming mold comprises a pre-forming shell mold 2 detachably spliced, the pre-forming shell mold 2 is provided with a pre-forming cavity 21 adapted to a structure of a formed product, an inner wall of the pre-forming cavity 21 is used for laying a plurality of layers of pre-forming layers 3 of carbon fiber composite materials, and the pre-forming layers 3 are used for forming pre-forming pieces 5 of products.

On this basis, the present disclosure also discloses a forming mold for a carbon fiber composite material, the forming mold comprises a curing mold 1, an air pipe and the above-mentioned pre-forming mold for the carbon fiber composite material, the curing mold 1 is provided with a curing cavity 11 used for containing the pre-forming shell mold 2, the air pipe is arranged in the pre-forming cavity 21, the air pipe adopts a nylon air pipe 4, and the nylon air pipe 4 supports the pre-molding layer 3 to be tightly attached to the inner wall of the pre-molding cavity 21 in an inflated state.

The pre-forming shell mold 2 comprises a plurality of groups of split shell molds spliced together. The two adjacent groups of the split shell molds are detachably spliced by means of an engaging structure 26. The engaging structure 26 usually includes two parts: a buckle and a bayonet. By inserting the buckle into the bayonet for snap-fastening, the two adjacent groups of the split shell molds can be fixed and spliced.

The curing mold 1 includes an upper curing mold 12 and a lower curing mold 13, the upper curing mold 12 is arranged right above the lower curing mold 13 in a lifting mode, a bottom side of the upper curing mold 12 is provided with an upper curing groove 121, a top side of the lower curing mold 13 is provided with a lower curing groove 131, and the upper curing groove 121 and the lower curing groove 131 are matched to form the curing cavity 11 used for containing the pre-forming shell mold 2.

The pre-forming layer 3 includes a plurality of layers and is made of carbon fiber composite material. The layers of the pre-forming layer 3 at different locations can be adjusted according to actual needs. For example, several more layers can be laid for reinforcement in parts that need reinforcement.

The curing mold 1 is made of a metal material, and the pre-forming shell mold 2 is made of a plastic material.

There is no need to use a release agent when forming products using this forming mold, and the product is easy to demould. After demolding, the curing mold 1 is clean, free of residue, and can be used sustainably. Moreover, the cost of the mold is relatively low.

In order to further prevent material from remaining in the metal curing mold 1, a plurality of anti-overflow cavities 25 are provided on the pre-forming shell mold 2, and the anti-overflow cavities 25 are communicated with the pre-molding cavity 21. The anti-overflow cavity 25 can receive and store excess resin or other materials that overflow from the pre-forming cavity 21 to prevent resin and other overflow materials from remaining in the metal curing mold 1 and contaminating the metal curing mold 1.

The anti-overflow cavity 25 can communicate with the pre-forming cavity 21 through the splicing gap between adjacent groups of split shell molds 13. Correspondingly, an anti-overflow groove 251 is provided on part or all of the split shell molds 13. The anti-overflow cavity 25 is formed by cooperation between the anti-overflow grooves 251 on a plurality of adjacent groups of the split shell molds 13, or by cooperation between the anti-overflow grooves 251 and splicing surfaces on a plurality of adjacent groups of the split shell molds 13.

The anti-overflow cavity 25 is located outside the pre-forming cavity 21, and its specific location is arranged according to the shape of the product, and can be arranged at a location where glue overflow is more likely to occur. However, preferably, each anti-overflow cavity 25 is arranged along the contour line of the pre-forming cavity 21, thereby enhancing the protection effect.

In addition, in order to meet specific product appearance requirements, a first texture 27 is provided on the inner wall surface of the pre-forming cavity 21 of the pre-forming shell mold 2, and the first texture 27 is configured to correspondingly form the second texture 51 on the appearance surface of the pre-forming piece 5 during the heating and pressurizing process, thereby forming the second texture 51 on the appearance surface of the product. The first texture 27 may protrude or be recessed from the inner wall surface of the pre-forming cavity 21, or may be partially convex and partially recessed, and when the first texture 27 is arranged in a protruding manner, the second texture 51 on the pre-forming piece 5 corresponds to recess, and when the first texture 27 is recessed, the second texture 51 on the pre-forming piece 5 corresponds to protrusion.

The specific shape and position of the first texture 27 are adjusted according to the appearance requirements of the product. The second texture 51, correspondingly formed on the pre-forming piece 5, is clear in texture, smooth in line, and free of distortion. After curing and forming, the formed product retains these qualities, ensuring good texture quality and low manufacturing difficulty.

Similarly, according to the appearance requirements of the product, the inner wall surface of the pre-forming cavity 21 may be a combination of one or both of the matte surface 28 and the polishing surface 271 to form the pre-forming piece matte surface 52 and/or the pre-forming piece polishing surface 53, thereby saving subsequent grinding and polishing.

The present disclosure also discloses a preparation method for a carbon fiber composite material, using the above-mentioned forming mold for the carbon fiber composite material for preparing, which specifically comprises the following steps:
Step 1, pre-manufacturing a plurality of groups of split shell molds, and laying a carbon fiber composite material on the inner sides of the split shell molds to form pre-forming layers 3;
Step 2, assembling and combining the plurality of groups of split shell molds to form a pre-forming shell mold 2, tightly connecting and matching the pre-forming layers 3 on the inner sides of each group of the split shell molds to form a pre-forming piece 5 of a product, and pre-placing the nylon air pipe 4 into an inner portion of the pre-forming piece 5;
Step 3, inflating air into the nylon air pipe 4, and keeping the pressure for a few seconds, so that the nylon air pipe 4 expands to support the pre-forming layers 3 to be tightly attached to the inner wall of a pre-forming cavity 21 of the pre-forming shell mold 2;
Step 4, placing the pre-forming shell mold 2 into a curing cavity 11 of a curing mold 1, heating the curing mold 1, and pressurizing the nylon air pipe 4, wherein the heating process and the pressurization process are performed at the same time until the temperature and the pressure reach the requirement of curing forming, and then the pressure is continuously kept until the pre-forming piece 5 is completely formed and cured to form an initial product; and
Step 5, opening the curing mold 1, stripping off the pre-forming shell mold 2 from the surface of the initial product, taking out the initial product, and performing machining on the initial product to obtain a finished product.

In this embodiment, the formed product specifically takes a bicycle rim as an example. The split shell mold 2 includes three groups: an upper shell mold 22, a lower shell mold 23 and an outer ring shell mold 24.

The upper shell mold 22 is provided with a first buckle inside, and the lower shell mold 23 is provided with a first bayonet adapted to the first buckle inside. Preferably, the first buckle and the first bayonet adopt a matched strip-shaped concave-convex structure, that is, the strip-shaped protrusion 261 and the strip-shaped groove 262 are shown, and after the strip-shaped protrusion 261 and the strip-shaped groove 262 are clamped with each other, the upper shell mold 22 and the lower shell mold 23 can be spliced and fixed.

The outer sides of the upper shell mold 22 and the lower shell mold 23 are both provided with second bayonets, and the two lower ends of the outer ring shell mold 24 are respectively provided with second buckles matched with the second bayonets. Preferably, the second bayonet and the second buckle adopt mutually matched holes and column structures, that is, the clamping hole 264 and the first clamping column 263 shown in the figure. The outer diameter of the first clamping column 263 is matched with the hole diameter of the clamping hole 264 and can be inserted into the clamping hole 264, and after the first clamping column 263 and the clamping hole 264 are clamped with each other, the upper shell mold 22, the lower shell mold 23 and the outer ring shell mold 24 can be spliced and fixed.

The outer ring shell mold 24 is divided into a plurality of sections along the circumferential direction of the pre-forming cavity 21, a third buckle and a third bayonet are arranged at the head and tail of each section of the outer ring shell mold 24. Preferably, the third buckle and the third bayonet adopt matched hook and column structures, that is, the second clamping column 265 and the clamping hook 266 shown in the figure are clamped with each other, and then the outer ring shell mold 24 of each section can be spliced to form a circle.

A plurality of anti-overflow cavities 25 are formed by matching the split shell molds 13, wherein the partial anti-overflow cavities 25 are formed by buckling the anti-overflow grooves 251 formed on the upper shell mold 22 and the lower shell mold 23; the partial anti-overflow cavities 25 are formed by the anti-overflow groove 251 formed on the upper shell mold 22 and a splicing surface formed by splicing the anti-overflow groove 251 and the outer ring shell mold 24; and the partial anti-overflow cavities 25 are formed by the anti-overflow groove 251 formed on the lower shell mold 23 and a splicing surface formed by splicing the anti-overflow groove 251 and the outer ring shell mold 24. Each anti-overflow cavity 25 is arranged along the contour line of the pre-forming cavity 21.

In addition, the inner wall surface of the pre-forming cavity 21, enclosed by the split shell mold 13, is provided with a convex first texture 27, the part of the inner wall surface of the pre-forming cavity 21 outside the first texture 27 is a matte surface 28, and the part located above the first texture 27 is a polishing surface 271.

Corresponding to the split shell mold, the pre-forming layer 3 includes four groups: an upper pre-forming layer 31, a lower pre-forming layer 32, an outer ring pre-forming layer 33, and an inner ring pre-forming layer 34.

The specific forming method includes the following steps:
1) pre-manufacturing the upper shell mold 22, the lower shell mold 23 and the outer ring shell mold 24, and laying the upper pre-forming layer 31, the lower pre-forming layer 32 and the outer ring preform layer 33 on the inner side of the upper shell mold 22, the lower shell mold 23 and the outer ring shell mold 24, respectively;
2) placing the outer ring shell mold 24 and the inner ring pre-forming layer 34 respectively to the both ends of the inner side of the lower shell mold 23 for assembly, and placing the nylon air pipe 4 between the outer ring shell mold 24, the inner ring pre-forming layer 34 and the lower shell mold 23;
3) the inner ring pre-forming layer 34 is pre-laid and formed by an external pre-forming fixture, and then the laid inner ring pre-forming layer 34 is placed on the lower shell mold 23 to be combined, the upper shell mold 22, the lower shell mold 23 and the outer ring shell mold 24 are assembled and combined to form the pre-forming shell mold 2, and the upper pre-forming layer 31, the lower pre-forming layer 32, the outer ring pre-forming layer 33, and the inner ring pre-forming layer 34 are tightly connected to form a rim pre-forming piece 5; and
in the laying process of the upper pre-forming layer 31 and the lower pre-forming layer 32, the inner ring pre-forming layer 34 is gradually thinned near the inner ring pre-forming layer 34, thereby facilitating the flat and tight connection between the inner ring pre-forming layer 34 and the upper pre-forming layer 31 and the lower pre-forming layer 32; and the outer ring pre-forming layer 33 extends to both sides during the paving process, so that the outer ring pre-forming layer 33 is smoothly and tightly connected to the upper pre-forming layer 31 and the lower pre-forming layer 32, thereby ensuring the strength of the formed rim at the joint. Meanwhile, in the laying process of the pre-forming layer, local reinforcement is performed by thickening the laying at specific locations, such as the brake part and the spoke hole part.

The pre-forming shell mold 2 is further provided with a mounting hole 29 penetrating through the inner and outer sides of the pre-forming mold shell 2 and used for mounting a tire inflation nozzle fitting, and the end portion of the nylon air pipe 4 is led out from the mounting hole 29 and is connected to an inflation nozzle fitting.

4) Filling the nylon air pipe 4 with air via the inflation nozzle fitting, and keeping the pressure for a few seconds to make the nylon air pipe 4 expand to support the pre-forming layer 3 to be tightly attached to the inner wall of the pre-forming cavity 21 of the pre-forming shell mold 2;

5) placing the pre-forming shell mold 2 into the curing cavity 11 of the curing mold 1, heating the curing mold 1, meanwhile, pressurizing the nylon air pipe 4, performing the heating process and the pressurizing process simultaneously until the temperature reaches between 145° C. and 155° C., the pressure reaches between 1.5 MPa and 1.8 MPa, and then continuing to maintain pressure until the rim pre-forming piece 5 is completely formed and cured to form the rim; and

during the heating and curing molding process, the first texture 27, the matte surface 28, and the polishing surface 271 on the pre-forming cavity 21 correspondingly form the second texture 51, the pre-forming piece matte surface 52, and the pre-forming piece polishing surface 53 on the appearance surface of the pre-forming piece 5, and are cured and formed on the product after pressure is maintained. The second texture 51 is concave, the pre-forming piece matte surface 52 is formed outside the second texture 51, and the pre-forming piece polishing surface 53 is formed in the second texture 51.

During heating and curing, part of the resin that overflows the pre-forming cavity 21 from the splicing gap between the upper shell mold 22 and the lower shell mold 23, the splicing gap between the upper shell mold 22 and the outer ring shell mold 24, and the splicing gap between the lower shell mold 23 and the outer ring shell mold 24 permeates into the corresponding anti-overflow cavity 25, and will not remain on the curing mold 1.

6) Opening the curing mold 1, stripping off the pre-forming shell mold 2 from the surface of the rim, taking out the rim, and performing machining and surface treatment to obtain the finished rim.

The above are only preferred embodiments of the present disclosure, but the scope of protection of the present disclosure is not limited thereto, and any changes or substitutions that can be easily conceived of by those skilled in the art within the technical scope disclosed by the present disclosure shall fall within the protection scope of the present disclosure. Therefore, the protection scope of the present disclosure should be subject to the protection scope of the claims.

What is claimed is:

1. A pre-forming mold for a carbon fiber composite material, comprising a pre-forming shell mold detachably spliced, wherein the pre-forming shell mold is provided with a pre-forming cavity adapted to a structure of a formed product, an inner wall of the pre-forming cavity is used for laying a pre-forming layer, and the pre-forming layer is used for forming a pre-forming piece of a product.

2. The pre-forming mold for the carbon fiber composite material according to claim 1, wherein a first texture is provided on an inner wall surface of the pre-forming cavity, and the first texture is used for forming a second texture on an appearance surface of the pre-forming piece.

3. The pre-forming mold for the carbon fiber composite material according to claim 2, wherein the first texture is arranged convex or concave.

4. The pre-forming mold for the carbon fiber composite material according to claim 1, wherein the pre-forming shell mold comprises a plurality of groups of split shell molds spliced together, a plurality of anti-overflow cavities are provided on the pre-forming shell mold, and the anti-overflow cavities are communicated with the pre-molding cavity.

5. The pre-forming mold for the carbon fiber composite material according to claim 4, wherein an anti-overflow groove is provided on the split shell mold, and the anti-overflow cavity is formed by cooperation between the anti-overflow grooves on adjacent groups of the split shell molds, or by cooperation between the anti-overflow grooves and splicing surfaces on adjacent groups of the split shell molds.

6. The pre-forming mold for the carbon fiber composite material according to claim 4, wherein the anti-overflow cavity is arranged along a contour line of the pre-forming cavity.

7. The pre-forming mold for the carbon fiber composite material according to claim 4, wherein two adjacent groups of the split shell molds are detachably spliced by means of an engaging structure.

8. The pre-forming mold for the carbon fiber composite material according to claim 1, wherein the inner wall surface of the pre-forming cavity is one or a combination of a matte surface and a polishing surface.

9. A forming mold for a carbon fiber composite material, comprising a curing mold, an air pipe and the pre-forming mold for the carbon fiber composite material according to claim 1, wherein the curing mold is provided with a curing cavity used for containing the pre-forming shell mold, the air pipe is arranged in the pre-forming cavity, and the air pipe supports the pre-molding layer to be tightly attached to the inner wall of the pre-molding cavity in an inflated state.

10. The forming mold for the carbon fiber composite material according to claim 9, wherein the curing mold comprises an upper curing mold and a lower curing mold, the upper curing mold is arranged right above the lower curing mold in a lifting mode, a bottom side of the upper curing mold is provided with an upper curing groove, a top side of the lower curing mold is provided with a lower curing groove, and the upper curing groove and the lower curing groove are matched to form the curing cavity used for containing the pre-forming shell mold.

11. The forming mold for the carbon fiber composite material according to claim 9, wherein the pre-forming layer comprises a plurality of layers and is made of the carbon fiber composite material; and the pre-forming shell mold is made of a plastic material, and the curing mold is made of a metal material.
